(19) United States
(12) Patent Application Publication
(10) Pub. No.: US 2004/0112919 A1
(43) Pub. Date: Jun. 17, 2004

(54) Closure with integrated ventilation

(76) Inventors: Gunter Krautkramer, Budenheim (DE); Lothar Brauer, Budenheim (DE); Okten Gassner, Odernheim (DE); Axel Tombarge, Raunheim (DE)

Correspondence Address: STEVENS & SHOWALTER LLP, 7019 CORPORATE WAY, DAYTON, OH, 45459-4238, US

(21) Appl. No.: 10/478,529

(22) PCT Filed: Mar. 12, 2002
(86) PCT No.: PCT/DE02/00878

(30) Foreign Application Priority Data
May 22, 2001 (DE) 101 24 835.0

(51) Int. Cl. B67D 5/33

(52) U.S. Cl. 222/153.07; 222/481.5; 222/545

(57) ABSTRACT

The invention relates to a closure with integrated ventilation, comprising a pouring nozzle (1), a closing seal (2), which may be torn off and which closes the flow passage, fixing elements (3) for an essentially sealed connection with a container opening and ventilation tongues (4), extending radially inwards on a section of the pouring nozzle (1), lying axially on the inside of the closing seal (2). According to the invention, a closure with integrated ventilation in which the known positive pouring properties of closures provided with tongues is retained, whilst also providing a rapid pouring of liquids avoiding an uneven glugging of the pouring fluid caused by a corresponding incremental intake of air bubbles into the container may be achieved, whereby the ventilation elements are comprised partly of tongues (4) extending radially into the flow passage, which are separated by slots and partly of openings (5) in the wall of the flow passage (2) in the region between the tongues and the closing seal (2).

The present invention concerns a closure with integrated ventilation, comprising a pouring spout, a closure seal which closes the discharge cross-section and which can be pulled out, fixing and sealing elements for substantially sealing connection to a container opening, and ventilation elements at a portion of the pouring spout which is disposed axially within the fixing elements.

Corresponding closures are known for example from bottles for edible oil. The tabs which project radially inwardly from the axially inward end of the pouring spout, by virtue of the reduction in cross-section afforded thereby, result in a marked constriction of the pouring jet in relation to the overall discharge cross-section, in which respect the edible oil which is of a higher viscosity in comparison with aqueous liquids does not penetrate through the slots between the tabs so that those slots act as air intake openings. Bellows closures are also known, in which the tabs are directed in the axial direction or radially outwardly, in the inwardly turned condition of the bellows, and are pivoted radially inwardly only by virtue of the closure bellows portion being pulled out. These tabs which are generally somewhat larger and wider and which can also partially overlap each other also involve a similar function and effect to the corresponding tabs in closures without a bellows portion.

It has been found however that, in relation to many liquids, the ventilation effect of the closures provided with such tabs is only insufficient so that, particularly when the liquid is poured out quickly, air repeatedly penetrates into the container spasmodically, which conversely also results in the liquid flowing out in a surging and non-constant flow so that the liquid is easily spilt.

On the other hand the closures with the radially inwardly projecting tabs have certainly proved satisfactory when the liquid is poured out less quickly, and they produce a relatively homogeneous, thin jet of liquid.

In comparison with that state of the art the object of the present invention is to provide a closure with integrated ventilation, in which on the one hand the known positive pouring properties of closures provided with tabs are retained while on the other hand when liquids are poured out rapidly irregular, surge-like discharge of liquid is avoided, which is caused by a correspondingly spasmodic ingress of bubbles of air into the container.

That object is attained in that the ventilation elements for the one part comprise both tabs which project radially into the pouring cross-section and which are separated from each other by narrow slots but for the other part also openings in the wall of the pouring spout, which are provided in the region between the tabs and the closure seal or the attachment point for the fixing elements.

In specific terms, this means that the wall of the pouring spout which still to a certain extent projects into the interior of the container is apertured in that part projecting into the container and immediately axially outside the ventilation tabs and in that way has additional venting openings. Those additional ventilation openings, when pouring out liquid, provide for a constant flow of the liquid which is to be poured out, even if the corresponding container is severely tilted in the full condition and even if liquids of relatively low viscosity are being poured out.

In the preferred embodiment of the invention the fixing elements comprise a fixing foot which extends in an annular configuration around the tubular pouring spout and which is mounted to the outside thereof and which is of a U-shaped profile cross-section. That U-shaped annular profile is fitted generally on to a substantially cylindrical container edge which stands up somewhat, wherein the radially inward limb of the U-shaped closure foot accordingly projects into the interior of the container and preferably latches with a corresponding outer ridge behind the inner edge of the container opening.

Desirably it is provided in that respect that on the one hand the additional ventilation openings overlap in the axial direction with the inner leg of the closure foot and on the other hand the inner annular leg has periodic interruptions in its lower edge projecting into the interior of the container, those interruptions being aligned with the ventilation openings. In that way, when a container is almost empty, the ventilation openings serve as pouring openings for emptying the remainder of the contents of the container as completely as possible. More specifically, when a container is turned over with the closure side downwardly, it can otherwise happen that the liquid on the outside of an otherwise closed, inwardly projecting pouring spout becomes dammed up and cannot flow away through same. That can also occur in principle due to the inner limb, which projects into the container, of the closure foot. It is for that reason that this closure foot has periodic interruptions and, by virtue of the overlap of the ventilation opening with that inner limb of the closure foot, the arrangement provides that liquid which passes through the interruptions in the closure foot can also flow away through the ventilation openings and the pouring spout. In that respect the alignment of the ventilation openings with the interruptions in the closure foot involves the purpose of if possible accelerating the discharge flow of residual amounts of the liquid. In particular however that alignment relationship facilitates a continuous intake flow of air during the normal procedure of pouring out liquid, and thus markedly improves the ventilation effect.

Desirably the substantially flat, radially inwardly projecting tabs include with the axis of the closure an angle of less than 90°, preferably between 30° and 65°, and in addition they are preferably of a smaller wall thickness than the pouring spout. Added to that is the fact that the ring of tabs is attached to the axially and radially inward edge with an annular attachment portion and that the additional ventilation openings preferably extend as far as the inner end of the pouring spout. In other words, the additional ventilation openings appear open in an end view from the inside on to the pouring spout and are closed only by a ring which is attached to the radially inward edge of the pouring spout and which bears the inwardly projecting tabs.

This facilitates one-piece manufacture of the corresponding pouring spout with comparatively simple tools as now the openings can be produced with tools which are movable exclusively axially. A further contribution in that respect is afforded by virtue of the ventilation tabs which are inclined with respect to the closure axis and which, by virtue of their inclination and their relatively thin-walled configuration, are relatively easily movable so that they can be produced solely by an axially inwardly movable injection molding tool. In that respect it is to be noted inter alia that, because of the closure seal provided, a corresponding tool cannot be introduced into the pouring spout from the exterior and moved as far as the tabs and the ventilation openings. The combination of the tabs with a certain inclination with respect to the closure axis, the thin wall thickness thereof and the arrangement of the ring of tabs radially within the wall of the pouring spout while the ventilation openings extend at the end as far as the inner end of the spout permits one-piece manufacture of the closure also with the closure seal.

The closure foot which is mounted to the pouring spout at the outside also has only slight undercut configurations' in the axial direction and can therefore also be produced in one piece with the other parts of the pouring spout by a solely axially movable tool, using an injection molding process.

Conventional closures of the above-described kind (without the characterising features of the invention) often presuppose a container opening having a neck which has an outwardly projecting projection or ridge behind which engages a ring embracing the container neck, or the outer leg of the closure foot.

That means however that the container neck must project correspondingly far from the surface of the container. Often however it is desirable for the closure to project only slightly from the surface of the container and for the opening of the container to have no edge or neck, or an edge or neck which projects only slightly, being too short for it to be able to have a ridge behind which the closure can engage from the outside. In that case the annular leg which projects into the container opening, besides the sealing function, must also guarantee a substantial holding function and hold the closure securely and in sealed relationship in the opening of the container. That leg must therefore be sufficiently strong but at the same time also sufficiently elastic to be introduced into the container opening with a close fit.

However, the additional provision of inwardly projecting ventilation tabs on the fixing leg is in conflict with the above-outlined required properties of that leg. If that annular leg is relatively stiff and in addition is also provided with inwardly projecting ventilation tabs and if moreover a closure seal also closes the opening cross-section of the pouring spout, then such a closure on the one hand can only be removed from the mold with very great difficulty while on the other hand the ventilation tabs mounted to the inside of the leg could additionally so severely increase the required stiffness of the leg that it can no longer be readily introduced into an opening in a container.

In a particular embodiment of the invention therefore the aim is to produce a one-piece closure of that kind which, with fixing elements which substantially ensure anchoring of the closure from the inside of a container opening, can nonetheless be easily fitted and at the same time guarantees a secure and sealing connection of the closure to the container.

In this embodiment therefore the ventilation elements are provided on a tubular portion which extends the pouring spout inwardly and which is arranged radially within the fixing element and which is formed integrally on the pouring spout.

This means that the properties of the fixing elements, in particular the annular fixing leg which projects into the container opening, are not adversely affected by the ventilation elements. At the same time the inner prolongation of the pouring spout, which is provided with the ventilation openings, can be produced in a suitable design configuration and in particular of a small wall thickness which permits the closure to be comparatively easily removed from the mold of an injection molding tool.

It will be noted that the present invention also involves embodiments in which the pouring spout is formed on the inside of the container, that is to say within the closure seal, immediately by the inner leg of the closure foot, wherein the ventilation tabs are correspondingly formed directly on that leg of the closure foot and wherein that leg of the closure foot also has the ventilation openings 5.

In addition, the present invention is also intended to embrace such embodiments in which the slots between the ventilation tabs extend into the ventilation openings so that in the final effect this provides for the formation of slots which not only extend between the tabs but also into the wall of the pouring spout and are there possibly widened. In this case also only a part of the slots between the tabs may involve a communication with the ventilation openings in the spout.

Further advantages, features and possible uses of the present invention will be clearly apparent from the description hereinafter of a preferred embodiment and the accompanying drawing in which:

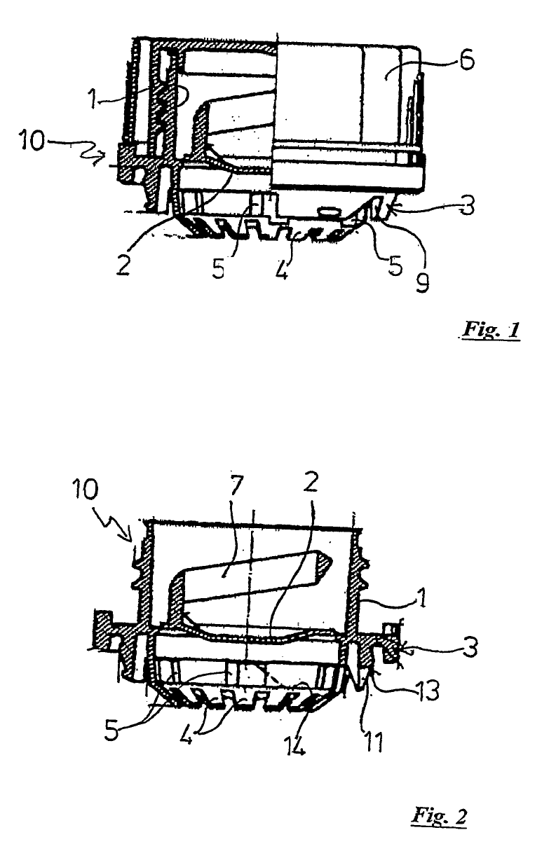

FIG. 1 is a partly sectional side view of a closure according to the invention (without closure cap), and

FIG. 2 shows an end view on to the closure from below or from the interior of a container.

Referring to FIG. 1 shown therein is a complete screw closure which substantially comprises a lower closure portion 10 and a screw cap 6. The lower closure portion 10 is shown again separately in FIG. 2, without the screw cap 6. FIG. 1 shows the closure in section in the left-hand half and as an outside view in the right-hand half.

The pouring spout 1 has a male screwthread, on to which the screw cap 6 can be screwed. It will be seen in FIG. 1 that, in the illustrated embodiment, the screw cap is of a double-wall structure in the sectional plane, which is specifically related to the function of a child-proof closure, as the illustrated closure is so designed that it cannot be opened by small children. This aspect however plays no part in regard to the present invention. In addition, below its screwthread, the pouring spout 1 has a closure foot 3 which is fitted to the spout 1 on the outside and which is of U-shaped cross-section. By virtue of its U-shaped cross-section that closure foot 3 can embrace the upstanding edge of an opening of a container, in which respect the container can either be made from sheet metal or from plastic material and the precise cross-section of the closure foot is such that the closure foot latches at the container edge or behind the container opening. For example the inner leg of the U-shaped closure foot 3, which can be clearly seen in cross-section in FIGS. 1 and 2, is of a substantially nose-shaped cross-section which on the one hand facilitates knocking the closure foot into a container opening and which at the same time also performs the desired retaining function. By virtue of that holding function which must be performed by the inner leg 13 of the closure foot 3 of U-shaped cross-section, that leg 13 is markedly longer than the short outer leg of the closure foot 3, the axial length of which at any event is also limited by the length of the opening edge which projects from the container opening. It will be appreciated however that the use of the present invention is not limited to containers with a relatively short container neck but it can obviously also be used in relation to other containers with a relatively long neck.

The pouring spout 1 has a closure seal 2 which at a spacing relative to the upper pouring opening completely closes the cross-section of the pouring spout 1 and which can be torn out by way of a pull ring 7. Along its outer periphery the seal 2 is connected to the pouring spout 1 by a suitably thin tearing seam. The pouring spout 1 is extended further inwardly beyond the closure seal 2, even if with a somewhat reduced diameter in the illustrated example. Provided at the inner end of the pouring spout, that is to say as seen from the closure seal 2 towards the inside of a corresponding container, are radially inwardly projecting ventilation tabs 4 which are separated from each other by narrow slots and which at the same time are also inclined through an angle of about 60° with respect to the closure axis 8. If necessary the ventilation tabs 4 could also be displaced axially in the direction of the closure seal 2.

By virtue of the fact that those ventilation tabs 4 project inwardly, they markedly reduce the discharge flow cross-section for the liquid which is to be poured out of the corresponding container through the pouring spout 1. In that respect the slots between the ventilation tabs 4 at least partially provide for a ventilation effect as the issuing liquid does not pass so easily into the comparatively narrow slots, particularly if, when a container is inclined to a greater or lesser degree, a part of the ventilation slots is at the upper edge of the flow of liquid.

It has been found however that the ventilation tabs 4 with the narrow slots arranged therebetween are not always sufficient to really ensure good ventilation of the container while liquid is being poured out so that the jet of liquid which issues in the pouring procedure flows out constantly and not spasmodically. A spasmodic discharge flow is caused in particular by virtue of the fact that, while liquid is being poured out, it is not possible for a corresponding amount of air to pass into the container, so that a reduced pressure is produced in the container, which ultimately temporarily interrupts the issuing jet of liquid so that a corresponding bubble of air can enter the container through the pouring opening so that a pressure equalisation effect occurs and the discharge flow of the liquid suddenly starts again, with a corresponding surge.

In accordance with the invention that effect can be prevented by additional ventilation openings 5 which can be seen in the wall of the pouring spout 1 between the ring of ventilation tabs 4 and the closure seal 2 which at the same time is also approximately at the height of the fixing elements in the form of the closure foot 3. Those additional ventilation openings 5 guarantee, even when pouring out liquids of relatively low viscosity which upon being poured out for example also flow through the narrow slots between the inwardly projecting tabs 4, that nonetheless sufficient continuous ventilation takes place while the liquids are being poured out.

It will be noted that the provision of corresponding ventilation means in a closure with a closure seal is not trivial as, by virtue of the closure seal 2 which is provided in one piece with the inner portion 10 of the closure, it is not possible for molding tools which could mold ventilation elements 4 and 5 to be introduced from the upper pouring opening of the pouring spout 1.

A corresponding injection molding tool therefore has to be designed in such a way that only the closure seal 2 with the pull ring 7 mounted thereon is produced with tool portions which pass into the pouring spout from above, while mold shaping tools which engage into the pouring spout 1 from below shape the underside of the closure seal 2 and at the same time must also provide the lower portion of the pouring spout 1 including the openings 5 and the tabs 4. It will be appreciated that the closure overall must be of such a design configuration that suitable injection molding tools have the lowest possible degree of complexity, in which respect obviously fast and simple removal from the mold must be possible so that such closure portions can be rationally produced.

For that reason the closure tabs are desirably provided at a peripherally extending tab ring 14, the outside diameter of which corresponds to the inside diameter of the lower edge of the pouring spout 1. It will be noted that this does not mean that the tab ring 14 with the tabs 4 must be a separate part, but it can very well be produced in one piece with the other parts or with the pouring spout 1 of the closure. However the lower end edge of the pouring spout 1 is not hidden by the tab ring 14. That design configuration makes it possible for the openings 5 to be simply openings in the lower edge of the pouring spout 1, which also involve the ends of the pouring spout 1. In other words, without the tab ring 14 and the tabs 4 carried thereon, the lower edge of the pouring spout 1 would be in the shape of a crown or would involve the shape of battlements which are formed by the openings 5. That makes it possible for the tool portions which form the openings 5 to be axially advanced exclusively from below, in which respect it will be appreciated that a further molding element is introduced from the interior into the lower opening between the tabs 4 in order to form the inner molding portions.

By virtue of the holding function which must be performed by the inner leg 13 of the closure foot 3 of U-shaped cross-section, in the preferred embodiment of the invention (for use on a very short container neck), that leg 13 is markedly longer than the short outer leg of the closure foot 3, the axial length of which is at any event also limited by the length of the opening edge which projects from the opening of the container. It will be appreciated however that the use of the present invention is not limited to containers with a relatively short neck but it can obviously also be used in relation to other containers with a relatively long container neck.

In addition it will be seen at bottom right in FIG. 2 that the inner legs 13 of the closure foot 3 also have recesses 11, wherein those recesses 111 are aligned in the radial direction with the recesses 5 at the lower edge of the pouring spout 1. Admittedly, those recesses 11 are in principle known from similar closure feet of other closures, but there they do not have any ventilation function whatsoever but serve exclusively for the purpose of allowing the liquid to flow out of a container as completely as possible, when the container is placed upside down, in which respect as far as possible no liquid is to accumulate outside the annular leg 13 of the closure foot 3.

If, as is provided in accordance with the present invention, the recesses 11 are aligned with the recesses 5, those recesses 11 at the same time also promote the ventilation function and conversely the ventilation openings 5 also serve as pouring openings for emptying the residual content of the container when the container is substantially empty and is tipped upside down.

As will be seen, the individual elements of the closure are of such an arrangement and configuration that, in spite of the provision of a closure seal 2, it is possible to produce a corresponding closure with tools which are not excessively complicated, in which respect the closure has particularly advantageous ventilation properties.

That applies in particular also to an embodiment in which the pouring spout is formed on the inside of the container by the inner leg 13 of the closure foot so that the ventilation tabs 4 and the ventilation openings 5 are provided directly at the leg 13.

1. A closure with integrated ventilation, comprising a pouring spout (1) and a closure seal (2) which closes the discharge flow cross-section and which can be torn out, fixing elements (3) for substantially sealing connection to a container opening, and radially inwardly projecting ventilation tabs (4) on a portion of the pouring spout (1), which is axially within the closure seal (2), characterised in that the ventilation elements partially comprise tabs (4) which project radially into the discharge flow cross-section and which are separated from each other by slots and partially comprise openings (5) in the wall of the pouring spout (1) in the region between the tabs (4) and the closure seal (2).

2. A closure as set forth in claim 1 characterised in that the fixing elements (3) comprise a closure foot which extends peripherally at the outside of the pouring spout (1) and which is of U-shaped cross-section and which is provided for engagement with a substantially cylindrical edge of the opening of a container.

3. A closure as set forth in claim 2 characterised in that the ventilation openings (5) overlap in the axial direction with the radially inwardly disposed limb of the closure foot (3).

4. A closure as set forth in claim 2 or claim 3 characterised in that the radially inwardly disposed limb of the closure foot (3) has periodic interruptions which are preferably aligned in the radial direction with the ventilation openings (5).

5. A closure as set forth in one of claims 1 through 4 characterised in that on its outside adjoining the pouring opening the pouring spout has a male screwthread.

6. A closure as set forth in one of claims 1 through 5 characterised in that the radially inwardly projecting tabs (4) are arranged at the axially inner end of the pouring spout and are formed at the radially inward side of the pouring spout (1) so that they do not overlap or only slightly overlap in the radial direction with the wall of the pouring spout (1).

7. A closure as set forth in one of claims 1 through 6 characterised in that the radially inwardly projecting tabs include an angle of less than 90°, preferably between 30 and 65°, with the closure axis, and are of a markedly smaller wall thickness than the pouring spout.

8. A closure as set forth in one of claims 1 through 7 characterised in that the tabs are provided in a number of at least ten in a ring-like configuration with separating slots therebetween, which are radially inwardly open.

9. A closure as set forth in one of claims 1 through 8 characterised in that the radial dimension of the tabs (4) is less than a fifth of the inside diameter of the pouring spout.

10. A closure as set forth in one of claims 1 through 9 characterised in that the ventilation elements are provided on a tubular portion which extends the pouring spout inwardly and which is arranged radially within the fixing elements and which is formed integrally on the pouring spout.
